(19) United States
(12) Patent Application Publication
(10) Pub. No.: US 2026/0016854 A1
(43) Pub. Date: Jan. 15, 2026

(54) DATA DELAY METHOD, APPARATUS, AND CIRCUIT, ELECTRONIC DEVICE, AND READABLE STORAGE MEDIUM

(71) Applicant: VIVO MOBILE COMMUNICATION CO., LTD., Dongguan (CN)

(72) Inventor: Piaohai SHEN, Dongguan (CN)

(73) Assignee: VIVO MOBILE COMMUNICATION CO., LTD., Dongguan (CN)

(21) Appl. No.: 19/333,317

(22) Filed: Sep. 18, 2025

Related U.S. Application Data
(63) Continuation of application No. PCT/CN2024/081792, filed on Mar. 15, 2024.

(30) Foreign Application Priority Data
Mar. 21, 2023 (CN) 202310273886.6

(51) Int. Cl. G06F 1/12

(52) U.S. Cl. CPC G06F 1/12

(57) ABSTRACT

A data delay method, apparatus, and circuit, an electronic device, and a readable storage medium, are provided. The data delay method is performed by an electronic device. The electronic device includes a data delay circuit, the data delay circuit includes N independent first registers, and the method includes: storing first data in a target register in an M^{th} clock cycle, where the target register is an L^{th} first register of the N first registers; and when M is greater than N, obtaining, in the M^{th} clock cycle, second data output by the target register, where the second data is data stored in the target register in an (M−N)^{th} clock cycle.

### CROSS-REFERENCE TO RELATED APPLICATIONS

This application is a continuation of International Application No. PCT/CN2024/081792, filed Mar. 15, 2024, which claims priority to Chinese Patent Application No. 202310273886.6, filed Mar. 21, 2023. The entire contents of each of the above-referenced applications are expressly incorporated herein by reference.

### TECHNICAL FIELD

This application pertains to the field of digital circuits, and specifically relates to a data delay method, apparatus, and circuit, an electronic device, and a readable storage medium.

### BACKGROUND

In the field of digital circuits, a common type of data delay circuit utilizes a plurality of stages of registers to register effective input data stage-by-stage for each clock pulse, so that data output by a last-stage register is delayed for a plurality of clock cycles compared with input data.

For example, in a clock cycle in which the input data is valid, the input data is stored in a data register 0, data Q output by the register 0 is stored in a data register 1, and so on. If the input data is invalid, the registers at each stage maintain a value of a previous clock cycle. After a plurality of clock cycles, an output value Q of a data register N−1 is final output data of the entire data delay circuit. In a clock in which data is valid, the data is updated at each stage of register. A larger data bit width or a larger quantity of register stages may result in high power consumption overheads of the data delay circuit. Therefore, in a related technology, there is a problem of high power consumption of data delay.

### SUMMARY

This application provides a data delay method, apparatus, and circuit, an electronic device, and a readable storage medium.

According to a first aspect, an embodiment of this application provides a data delay method, performed by an electronic device, where the electronic device includes a data delay circuit, the data delay circuit includes N independent first registers, and the method includes:
storing first data in a target register in an M^{th} clock cycle, where the target register is an L^{th} first register of the N first registers; and
in a case that M is greater than N, obtaining, in the M^{th} clock cycle, second data output by the target register, where the second data is data stored in the target register in an (M−N)^{th} clock cycle.

According to a second aspect, an embodiment of this application provides a data delay apparatus, applied to an electronic device, where the electronic device includes a data delay circuit, the data delay circuit includes N independent first registers, and the data delay apparatus includes:
a storage control module, configured to store first data in a target register in an M^{th} clock cycle, where the target register is an L^{th} first register of the N first registers; and
an obtaining module, configured to: in a case that M is greater than N, obtain, in the M^{th} clock cycle, second data output by the target register, where the second data is data stored in the target register in an (M−N)^{th} clock cycle.

According to a third aspect, an embodiment of this application provides a data delay circuit, including: a first counter, a second counter, a delay subcircuit, N first registers, a first selection element, and a second selection element, where N is an integer greater than 1; and
an input end of the first counter is electrically connected to an input end of the second counter through the delay subcircuit, an output end of the first counter is electrically connected to a control end of the first selection element, and an output end of the second counter is electrically connected to a control end of the second selection element;
N output ends of the first selection element are electrically connected to data input ends of the N first registers in one-to-one correspondence, and the first selection element is configured to control a data input end of the first selection element to communicate with a first register associated with a value of the first counter through a data output end of the first selection element; and
N input ends of the second selection element are electrically connected to the data input ends of the N first registers in one-to-one correspondence, and the second selection element is configured to control a data output end of the second selection element to communicate with the first register associated with the value of the first counter through a data input end of the second selection element.

According to a fourth aspect, an embodiment of this application provides an electronic device. The electronic device includes a processor, a memory, and a program or an instruction that is stored in the memory and that can be run on the processor, where when the program or the instruction is executed by the processor, the steps of the method according to the first aspect are implemented.

According to a fifth aspect, an embodiment of this application provides a readable storage medium. The readable storage medium stores a program or an instruction, and when the program or the instruction is executed by a processor, the steps of the method according to the first aspect are implemented.

According to a sixth aspect, an embodiment of this application provides a chip. The chip includes a processor and a communication interface, the communication interface is coupled to the processor, and the processor is configured to run a program or an instruction to implement the method according to the first aspect.

According to a seventh aspect, an embodiment of this application provides a chip. The chip includes the data delay circuit according to the third aspect.

According to an eighth aspect, an embodiment of this application provides a computer program product. The computer program product includes a computer program/instruction, and when the computer program/instruction is executed by at least one processor, the steps of the data delay method according to the first aspect are implemented.

In the implementations of this application, first data is stored in a target register in an M^{th} clock cycle, where the target register is an L^{th} first register of N independent first registers. In a case that M is greater than N, in the M^{th} clock cycle, second data output by the target register is obtained, where the second data is data stored in the target register in an (M−N)^{th} clock cycle. In this way, a data storage and/or read operation is performed on only one first register in one clock cycle. Compared with a related technology in which a data storage and read operation needs to be performed on each level of registers, the implementations of the present application can reduce power consumption of data delay.

### BRIEF DESCRIPTION OF DRAWINGS

To describe the technical solutions in the embodiments of this application, the following describes the accompanying drawings required for describing the embodiments of this application. Apparently, the accompanying drawings in the following description show merely some embodiments of this application, and a person of ordinary skill in the art may derive other drawings from these accompanying drawings without creative efforts.

FIG. 1 is a schematic flowchart of a data delay method according to an embodiment of this application;

FIG. 2 is a diagram of a structure of a data delay circuit according to an embodiment of this application;

FIG. 3 is a schematic flowchart of another data delay method according to an embodiment of this application;

FIG. 4 is a diagram of a structure of another data delay circuit according to an embodiment of this application;

FIG. 5 is a diagram of a structure of a data delay apparatus according to an embodiment of this application;

FIG. 6 is a diagram of a structure of another data delay apparatus according to an embodiment of this application;

FIG. 7 is a diagram of a structure of an electronic device according to an embodiment of this application; and

FIG. 8 is a diagram of a structure of another electronic device according to an embodiment of this application.

### DETAILED DESCRIPTION

The following describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application without creative efforts shall fall within the protection scope of this application.

The terms “first,” “second,” and the like in this specification and claims of this application are used to distinguish between similar objects instead of describing a specific order or sequence. It should be understood that the data used in such a way is interchangeable in proper circumstances, so that the embodiments of this application can be implemented in an order other than the order illustrated or described herein. In addition, in this specification and the claims, “and/or” indicates at least one of connected objects, and a character “/” generally indicates an “or” relationship between associated objects.

A data delay method provided in the embodiments of this application is described in detail below with reference to the accompanying drawings by using specific embodiments and application scenarios thereof.

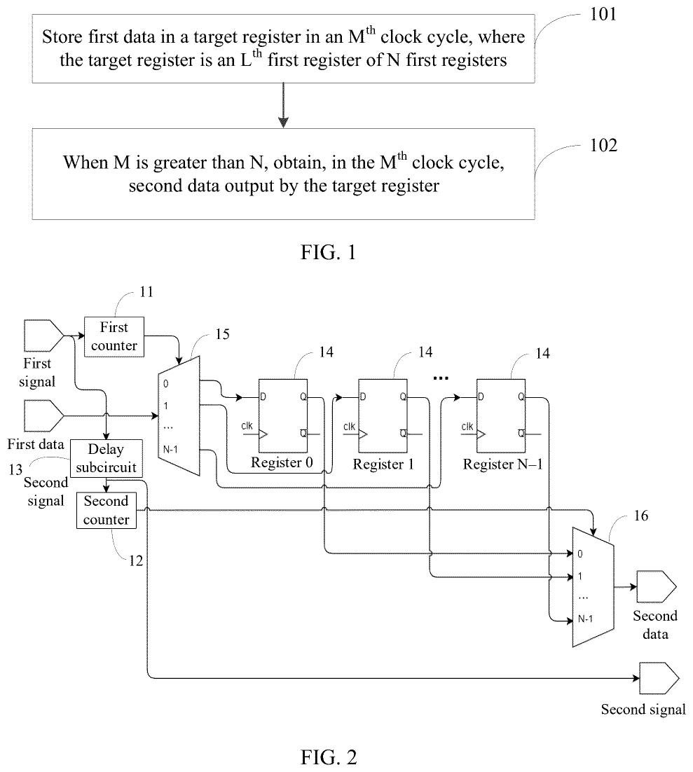

Refer to FIG. 1. FIG. 1 is a flowchart of a data delay method according to an embodiment of this application. The data delay method is performed by an electronic device. The electronic device includes a data delay circuit (as shown in FIG. 2), and the data delay circuit includes N independent first registers, as shown in FIG. 1. The data delay method includes the following steps:

Step 101: Store first data in a target register in an M^{th} clock cycle, where the target register is an L^{th} first register of the N first registers.

In some implementations of this application, the N independent first registers may be understood as that there is no electrical connection between data ports of the N first registers. Data output by one first register does not affect data currently stored in another first register. In other words, the data output by the first register is not written into the another first register as input data.

In some implementations, data may be sequentially and cyclically stored in the N first registers. Certainly, in some implementations, validity of a clock cycle may be further considered. For an invalid clock cycle, the data is not stored. In this case, data storage can be performed at intervals of one or more first registers to implement jump storage. A valid clock cycle may indicate that data corresponding to the clock cycle is valid, and an invalid clock cycle may indicate that data of the clock cycle is invalid. The valid clock cycle may include a valid clock cycle for a storage operation and a valid clock cycle for a read operation. A storage operation may be performed in the valid clock cycle for the storage operation, and a read operation may be performed in the valid clock cycle for the read operation.

In some implementations, there may be a correspondence between a value of L and a value of M modulo N. In some implementations, when M is an integer multiple of N, the value of L is the same as a value of N; or when M is not an integer multiple of N, the value of L is the same as the value obtained through M modulo N. For example, 1, 2, . . . , N−1, and 0 are obtained through M modulo N, which respectively correspond to a 1^{st} register, a 2^{nd} register, . . . , an (N−1)^{th} register, and an N^{th} register. In other words, data corresponding to the 1^{st} clock cycle is stored in the 1^{st} first register (that is, a register 0), and data corresponding to the 2^{nd} clock cycle is stored in the 2^{nd} first register (that is, a register 1). After N clock cycles, storage continues from the 1^{st} first register. In other words, data corresponding to the (N+1)^{th} clock cycle is stored in the 1^{st} first register (that is, the register 0), and data corresponding to the (N+2)^{th} clock cycle is stored in the 2^{nd} first register (that is, the register 1). In this way, a storage operation needs to be performed for only one first register in each clock cycle, thereby reducing power consumption overheads.

Step 102: In a case that M is greater than N, obtain, in the M^{th} clock cycle, second data output by the target register, where the second data is data stored in the target register in an (M−N)^{th} clock cycle.

It should be understood that data stored in the M^{th} clock cycle takes effect only in an (M+1)^{th} clock cycle. In other words, the data stored in the M^{th} clock cycle cannot be read in the M^{th} clock cycle, and data stored in an (M−N)^{th} clock cycle is read in the M^{th} clock cycle, that is, the data stored in the target register last time.

In some implementations of this application, because the data that is output by the target register and that is stored in the target register in the (M−N)^{th} clock cycle is obtained in the M^{th} clock cycle, the data is delayed by N clock cycles through the foregoing data delay circuit. For example, when M is equal to N+1, data stored in the 1^{st} first register in the 1^{st} clock cycle may be read from the 1^{st} first register. In some implementations, when M is equal to N+2, data stored in the 2^{nd} first register in the 2^{nd} clock cycle may be read from the 2^{nd} first register.

It should be noted that, when M is greater than N, data stored in an (M−N)^{th} cycle may be obtained from a corresponding first register in each clock cycle or each valid clock cycle.

In some implementations of this application, first data is stored in a target register in an M^{th} clock cycle, where the target register is an L^{th} first register of N independent first registers. In a case that M is greater than N, in the M^{th} clock cycle, second data output by the target register is obtained, where the second data is data stored in the target register in an (M−N)^{th} clock cycle. In this way, a data storage and/or read operation is performed on only one first register in one clock cycle. Compared with a related technology in which a data storage and read operation needs to be performed on each level of registers, the implementations of the present application can reduce power consumption of data delay.

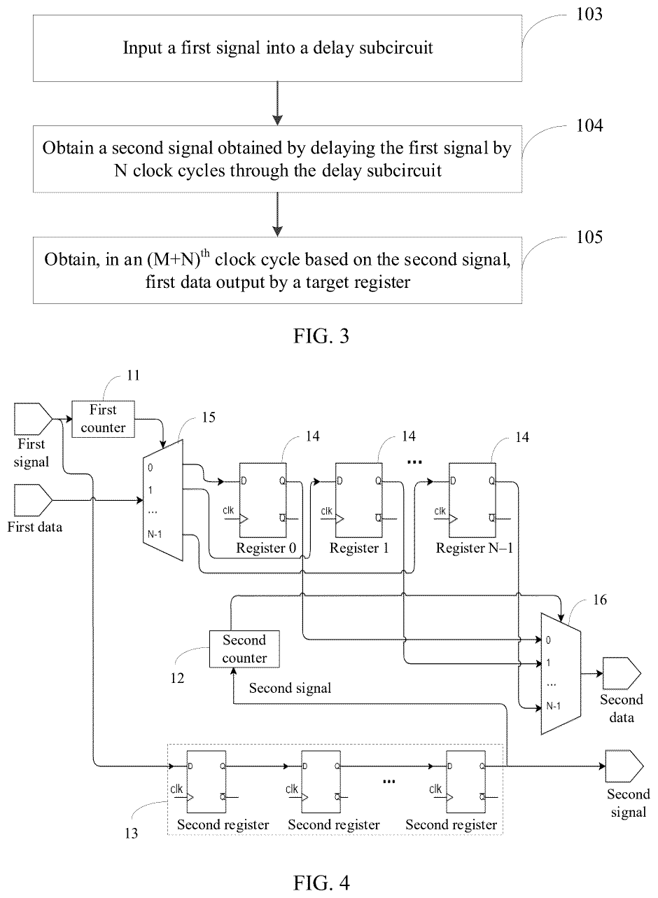

In some implementations, as shown in FIG. 2 and FIG. 3, in some implementations, the data delay circuit further includes a delay subcircuit formed by sequentially cascading N second registers.

That first data is stored in a target register in an M^{th} clock cycle includes:

In a case that a first signal is a valid signal, the first data is stored in the target register in the M^{th} clock cycle.

The method further includes:

Step 103: Input the first signal into the delay subcircuit.

Step 104: Obtain a second signal obtained by delaying the first signal by N clock cycles through the delay subcircuit.

Step 105: Obtain, in an (M+N)^{th} clock cycle based on the second signal, the first data output by the target register.

In some implementations of this application, each second register is configured to delay the first signal by one clock cycle, and the first signal may be delayed by N clock cycles by sequentially cascading the N second registers. It should be understood that the first signal and the second signal are consistent in type. To be specific, in a case that the first signal corresponding to the M^{th} clock cycle is a valid signal, the second signal corresponding to the (M+N)^{th} clock cycle is a valid signal. In some implementations, in a case that the first signal corresponding to the M^{th} clock cycle is an invalid signal, the second signal corresponding to the (M+N)^{th} clock cycle is an invalid signal.

In some implementations, in the M^{th} clock cycle, when the first signal is a valid signal, the first data corresponding to the M^{th} clock cycle may be stored in the target register. Similarly, in the (M+N)^{th} clock cycle, the corresponding second signal is a valid signal. In this case, the first data output by the target register may be obtained in the (M+N)^{th} clock cycle.

It should be understood that the first signal and the second signal may be understood as validity signals, and indicate validity of data in a corresponding clock cycle, or indicate validity of the corresponding clock cycle. For example, that the first signal corresponding to the M^{th} clock cycle is a valid signal may be understood as that the M^{th} clock cycle is a valid clock cycle for a storage operation. That the second signal corresponding to the (M+N)^{th} clock cycle is a valid signal may be understood as that the (M+N)^{th} clock cycle is a valid clock cycle for a read operation. In some implementations of this application, signal validity is incorporated, so that data can be stored and read only for a clock cycle corresponding to the validity signal, thereby further reducing power consumption of the electronic device.

In some implementations, the data delay circuit further includes a first counter and a second counter, where a value of the first counter cycles between 1 and N, and a value of the second counter cycles between 1 and N.

In the M^{th} clock cycle, the value of the first counter is L; and in a case that M is greater than N, in the M^{th} clock cycle, the value of the second counter is L.

In some implementations of this application, the first counter and the second counter are configured to count a quantity of clock cycles. In some implementations, the first counter and the second counter may be configured to record a total quantity of clock cycles, or may be configured to record a quantity of valid clock cycles. A value of the first counter is used to determine a position of the first register that stores data, and a value of the second counter is used to determine a position of the first register that reads data.

For example, after each clock cycle or valid clock cycle, the first counter and the second counter perform an increment operation of 1. The first counter and the second counter are used to record the quantity of clock cycles or valid clock cycles. In addition, the position of the first register that stores data is determined based on the value of the first counter, and the position of the first register that reads data is determined based on the value of the second counter. In this way, the first register on which the storage operation and/or the read operation are performed can be quickly located, thereby reducing a latency of the data storage operation and/or the data read operation.

In some implementations, the first counter performs a first counting operation in a case that a first signal is received and the first signal is a valid signal.

The second counter performs a second counting operation in a case that a second signal is received and the second signal is a valid signal.

In some implementations of this application, in a case that the first counter receives the first signal and the first signal is a valid signal, it may be considered that a current clock cycle is a valid clock cycle, so that the first counter is controlled to increase by 1. It should be understood that if a current value of the first counter is N, the value of the first counter is 1 after the first counter performs the first counting operation.

Similarly, in a case that the second counter receives the second signal and the second signal is a valid signal, it may be considered that a current clock cycle is a valid clock cycle, so that the second counter is controlled to increase by 1. It should be understood that if a current value of the second counter is N, the value of the second counter is 1 after the second counter performs the second counting operation.

Refer to FIG. 2, an embodiment of this application provides a data delay circuit. As shown in FIG. 2, the data delay circuit provided in some implementations of this application includes: a first counter 11, a second counter 12, a delay subcircuit 13, N first registers 14, a first selection element 15, and a second selection element 16, where Nis an integer greater than 1.

An input end of the first counter 11 is electrically connected to an input end of the second counter 12 through the delay subcircuit 13, an output end of the first counter 11 is electrically connected to a control end of the first selection element 15, and an output end of the second counter 12 is electrically connected to a control end of the second selection element.

N output ends of the first selection element 15 are electrically connected to data input ends of the N first registers 14 in one-to-one correspondence, and the first selection element is configured to control a data input end of the first selection element 15 to communicate with a first register 14 associated with a value of the first counter through a data output end of the first selection element 15.

N input ends of the second selection element are electrically connected to the data output ends of the N first registers 14 in one-to-one correspondence, and the second selection element 16 is configured to control a data output end of the second selection element 16 to communicate with the first register 14 associated with the value of the first counter through a data input end of the second selection element 16.

In some implementations of this application, increments of each count of the first counter 11 and the second counter 12 may be 1, and a cyclic counting range may be 1 to N, or may be 0 to N−1.

In some implementations, the first counter 11 and the second counter 12 are configured to count a quantity of clock cycles. In some implementations, the first counter and the second counter may be configured to record a total quantity of clock cycles, or may be configured to record a quantity of valid clock cycles. A value of the first counter 11 is used to determine a position of the first register 14 that stores data, and a value of the second counter 12 is used to determine a position of the first register 14 that reads data.

For example, after each clock cycle or valid clock cycle, the first counter 11 and the second counter 12 perform an increment operation of 1. The first counter 11 and the second counter 12 are used to record the quantity of clock cycles or valid clock cycles. In addition, the position of the first register 14 that stores data is determined based on the value of the first counter 11, and the position of the first register 14 that reads data is determined based on the value of the second counter 12. In this way, the first register 14 on which the storage operation and/or the read operation are performed can be quickly located, thereby reducing a latency of the data storage operation and/or the data read operation.

In some implementations, the first counter 11 may increment by 1 in each clock cycle. Starting from 1, the first counter 11 counts up to N before proceeding to a next counting round. For the second counter 12, a counting principle is the same as that of the first counter 11.

In some implementations, the first counter 11 may increment by 1 for each valid clock cycle. For example, when the first counter 11 receives the first signal in the M^{th} clock cycle and the first signal is a valid signal, the first counter 11 increases by 1. After counting up to N, the first counter 11 proceeds to a next counting round. For the second counter 12, a counting principle is the same as that of the first counter 11. A difference lies in that a counting object of the second counter 12 is the second signal. To be specific, in the M^{th} clock cycle, the second counter 12 increases by 1 when the second counter 12 receives the second signal and the second signal is a valid signal.

In some implementations, specific structures of the first selection element 15 and the second selection element 16 may be configured according to an actual requirement. For example, in some implementations, a multiplexer may be used. In other words, the first selection element 15 and/or the second selection element 16 may be a one-of-N selector.

In some implementations, it may be assumed that the data output end of the first selection element 15 includes a port 0 to a port N−1. When a first count value is 1, the port 0 of the first selection element 15 is connected to the data input port of the first selection element 15. In this way, data input from the data input port may be stored in the register 0 through the port 0. Similarly, it is assumed that the data output port of the second selection element 16 includes a data output port 0 to a data output port N−1. When the second count value is 1, the data input port of the second selection element 16 is connected to the data output port 0 of the first selection element 15, to obtain data output by the register 0.

It should be understood that there may be a plurality of output ends of the first counter 11 and the second counter 12. For example, when N is 16, there may be four output ends of the first counter 11 and four output ends of the second counter 12, so that a 4-bit count value may be output.

In some implementations, a structure of the delay subcircuit 13 may be configured according to an actual requirement. For example, as shown in FIG. 4, in some implementations, the delay subcircuit 13 may be formed by cascading N second registers. For example, the first signal may be input to an input end of a first-stage second register. In a process in which the first signal is transferred in the N second registers, in each clock cycle, an output of a previous-stage second register may be used as an input of a next-stage second register, and data output by an output end of a last-stage second register is the second signal, that is, a signal obtained by delaying the first signal by N clock cycles through the N second registers.

In some implementations of this application, the first counter 11, the second counter 12, the delay subcircuit 13, the N first registers 14, the first selection element 15, and the second selection element 16 cooperate to form a data delay circuit, thereby implementing the foregoing data delay method. In this way, a data storage and/or read operation is performed on only one first register in one clock cycle. Compared with a related technology in which a data storage and read operation needs to be performed on each level of registers, the implementations of the present application can reduce power consumption of data delay.

It should be noted that the first counter and the second counter may be further implemented by using another control chip having a data processing function. In some implementations, a structure of another logic gate circuit may be used for implementation. This is not further limited herein. In addition, the foregoing selection element may be implemented by using a multi-pole single-throw switch in cooperation with a control chip. This is not further limited herein.

In some implementations, an example in which a data bit width is 120 bits (bits), and a delay is 16 stages (that is, N and M are equal to 16, and the delay is 16 clock cycles) is used. A power consumption evaluation tool is used to compare power consumption of a conventional data delay circuit with that of the data delay circuit of this application, and the following data is obtained: The power consumption of the conventional data delay circuit is 0.2806 m W, while the power consumption of the data delay circuit of this application is 0.0509 mW, representing a reduction of 81.86%. Therefore, the data delay circuit provided in this application offers greater benefits in a scenario with a larger data width and a higher quantity of delay stages.

It should be noted that, the data delay method provided in some implementations of this application may be performed by a data delay apparatus or a control module that is in the data delay apparatus and that is configured to load the data delay method. In some implementations of this application, the data delay apparatus provided in the implementations of this application is described by using an example in which the data delay apparatus executes and loads the data delay method.

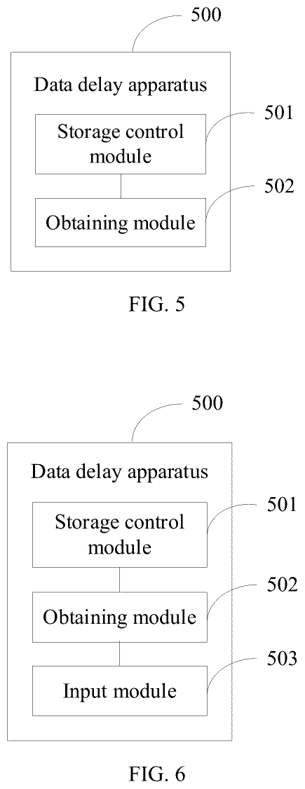

Refer to FIG. 5. An embodiment of this application further provides a data delay apparatus. As shown in FIG. 5, the data delay apparatus is applied to an electronic device. The electronic device includes a data delay circuit, the data delay circuit includes N independent first registers, and the data delay apparatus 500 includes:
a storage control module 501, configured to store first data in a target register in an M^{th} clock cycle, where the target register is an L^{th} first register of the N first registers; and
an obtaining module 502, configured to: in a case that M is greater than N, obtain, in the M^{th} clock cycle, second data output by the target register, where the second data is data stored in the target register in an (M−N)^{th} clock cycle.

In some implementations, the second data is delayed by N clock cycles relative to the first data.

In some implementations, the data delay circuit further includes a delay subcircuit formed by sequentially cascading N second registers, and the storage control module is specifically configured to: in a case that a first signal is a valid signal, store the first data in the target register in the M^{th} clock cycle.

In some implementations, as shown in FIG. 6, the data delay apparatus 500 further includes:
an input module 503, configured to input the first signal into the delay subcircuit; and
the obtaining module 502 is further configured to: obtain a second signal obtained by delaying the first signal by N clock cycles through the delay subcircuit; and obtain, in an (M+N)^{th} clock cycle based on the second signal, the first data output by the target register.

In some implementations, the data delay circuit further includes a first counter and a second counter, where a value of the first counter cycles between 1 and N, and a value of the second counter cycles between 1 and N.

In the M^{th} clock cycle, the value of the first counter is L; and in a case that M is greater than N, in the M^{th} clock cycle, the value of the second counter is L.

In some implementations, the first counter performs a first counting operation in a case that a first signal is received and the first signal is a valid signal.

The second counter performs a second counting operation in a case that a second signal is received and the second signal is a valid signal.

In some implementations, when M is an integer multiple of N, the value of L is the same as a value of N; or when M is not an integer multiple of N, the value of L is the same as the value obtained through M modulo N.

The data delay apparatus in some implementations of this application may be an apparatus, or may be a component, an integrated circuit, or a chip in a terminal. The apparatus may be a mobile electronic device, or may be a non-mobile electronic device. For example, the mobile electronic device may be a mobile phone, a tablet computer, a laptop computer, a palmtop computer, an in-vehicle electronic device, a wearable device, an Ultra-Mobile Personal Computer (UMPC), a netbook, or a Personal Digital Assistant (PDA). The non-mobile electronic device may be a server, a Network Attached Storage (NAS), a personal computer, a television, a teller machine, a self-service machine, or the like. This is not specifically limited in this embodiment of this application.

The data delay apparatus in some implementations of this application may be an apparatus with an operating system. The operating system may be an Android operating system, may be an iOS operating system, or may be another possible operating system. This is not specifically limited in this embodiment of this application.

The data delay apparatus provided in some implementations of this application can implement the processes implemented by the data delay apparatus in the method embodiments in FIG. 1 to FIG. 3. To avoid repetition, details are not described herein again.

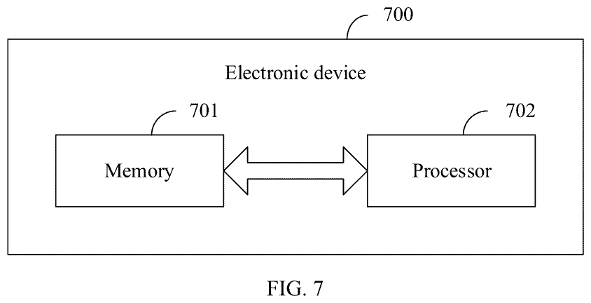

In some implementations, refer to FIG. 7. An embodiment of this application further provides an electronic device 700, including a processor 702, a memory 701, and a program or an instruction that is stored in the memory 701 and that can be run on the processor 702. When the program or the instruction is executed by the processor 702, the processes of the foregoing data delay method embodiments are implemented, and a same technical effect can be achieved. To avoid repetition, details are not described herein again.

It should be noted that the electronic device in some implementations of this application includes the foregoing mobile electronic device and the foregoing non-mobile electronic device.

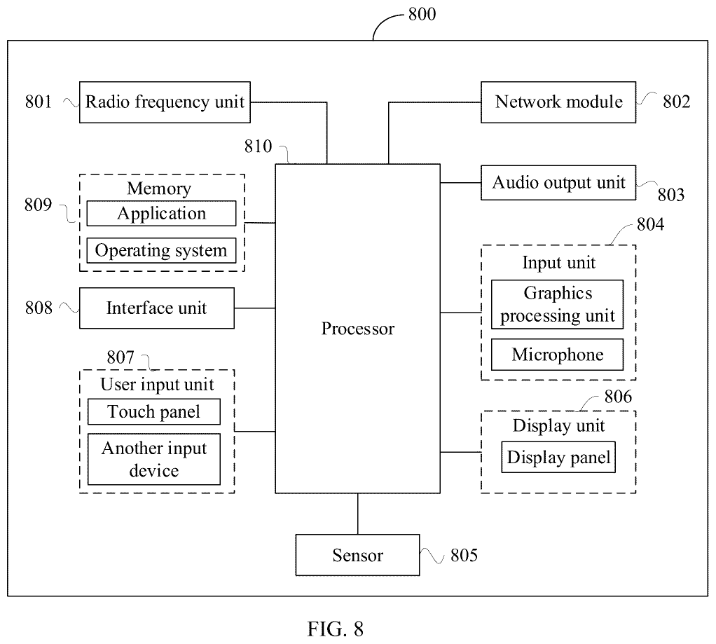

FIG. 8 is a diagram of a hardware structure of an electronic device for implementing embodiments of this application.

The electronic device 800 includes but is not limited to components such as a radio frequency unit 801, a network module 802, an audio output unit 803, an input unit 804, a sensor 805, a display unit 806, a user input unit 807, an interface unit 808, a memory 809, and a processor 810.

A person skilled in the art can understand that the electronic device 800 may further include the power supply (for example, a battery) that supplies power to each component. The power supply may be logically connected to the processor 810 by using a power supply management system, so as to manage functions such as charging, discharging, and power consumption by using the power supply management system. The structure of the electronic device shown in FIG. 8 does not constitute a limitation on the electronic device, and the electronic device may include more or fewer components than those shown in the figure, or combine some components, or have different component arrangements. Details are not described herein again.

The electronic device includes a data delay circuit, the data delay circuit includes N independent first registers, and the processor 810 is configured to: store first data in a target register in an M^{th} clock cycle, where the target register is an L^{th} first register of the N first registers; and in a case that M is greater than N, obtain, in the M^{th} clock cycle, second data output by the target register, where the second data is data stored in the target register in an (M-N)^{th} clock cycle.

In some implementations, the data delay circuit further includes a delay subcircuit formed by sequentially cascading N second registers, and the processor 810 is further configured to: input the first signal into the delay subcircuit; obtain a second signal obtained by delaying the first signal by N clock cycles through the delay subcircuit; and obtain, in an (M+N)^{th} clock cycle based on the second signal, the first data output by the target register.

In some implementations, the data delay circuit further includes a first counter and a second counter, where a value of the first counter cycles between 1 and N, and a value of the second counter cycles between 1 and N.

In the M^{th} clock cycle, the value of the first counter is L; and in a case that M is greater than N, in the M^{th} clock cycle, the value of the second counter is L.

In some implementations, the first counter performs a first counting operation in a case that a first signal is received and the first signal is a valid signal.

The second counter performs a second counting operation in a case that a second signal is received and the second signal is a valid signal.

In some implementations, when M is an integer multiple of N, the value of L is the same as a value of N; or when M is not an integer multiple of N, the value of L is the same as the value obtained through M modulo N.

It should be noted that, in some implementations of this application, the processor may be any module that includes a processing function, for example, a processing chip such as a Central Processing Unit (CPU), a Graphics Processing Unit (GPU), a Neural Processing Unit (NPU), a Digital Signal Processor (DSP), or an Image Signal Processor (ISP).

An embodiment of this application further provides a readable storage medium. The readable storage medium stores a program or an instruction, and when the program or the instruction is executed by a processor, the processes of the foregoing data delay method embodiment are implemented, and a same technical effect can be achieved. To avoid repetition, details are not described herein again.

The processor is a processor in the electronic device in the foregoing embodiment. The readable storage medium includes a computer-readable storage medium such as a computer Read-Only Memory (ROM), a Random Access Memory (RAM), a magnetic disk, or a compact disc.

An embodiment of this application further provides a chip. The chip includes a processor and a communication interface, the communication interface is coupled to the processor, and the processor is configured to run a program or an instruction to implement the processes of the foregoing data delay method embodiment, and a same technical effect can be achieved. To avoid repetition, details are not described herein again.

An embodiment of this application further provides a chip. The chip includes the foregoing data delay circuit.

It should be understood that the chip mentioned in some implementations of this application may also be referred to as a system-level chip, a system chip, a chip system, or an on-chip system chip.

An embodiment of this application further provides a computer program product. The computer program product includes a computer program/instruction, and when the computer program/instruction is executed by at least one processor, the processes of the foregoing data delay method embodiment are implemented, and a same technical effect can be achieved. To avoid repetition, details are not described herein again.

It should be noted that, in this specification, the term “include,” “comprise,” or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the descriptions of the foregoing implementations, a person skilled in the art may understand that the method in the foregoing embodiment may be implemented by software in addition to a necessary universal hardware platform or by hardware only. In most circumstances, the former is a preferred implementation. Based on such an understanding, the technical solutions of this application essentially, or the part contributing to the prior art may be implemented in a form of a software product. The computer software product is stored in a storage medium (for example, a ROM/RAM, a magnetic disk, or a compact disc), and includes a plurality of instructions for instructing a terminal (which may be a mobile phone, a computer, a server, an air conditioner, a network device, or the like) to perform the method described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

The invention claimed is:

1. A data delay method, performed by an electronic device, wherein the electronic device comprises a data delay circuit, the data delay circuit comprises N independent first registers, and the method comprises:
storing first data in a target register in M^{th} clock cycle, wherein the target register is L^{th} first register of the N first registers; and
when M is greater than N, obtaining, in the M^{th} clock cycle, second data output by the target register, wherein the second data is data stored in the target register in (M−N)^{th} clock cycle.

2. The method according to claim 1, wherein the data delay circuit further comprises a delay subcircuit formed by sequentially cascading N second registers, wherein the storing first data in a target register in M^{th} clock cycle comprises:
when a first signal is a valid signal, storing the first data in the target register in the M^{th} clock cycle; and
the method further comprises:
inputting the first signal into the delay subcircuit;
obtaining a second signal obtained by delaying the first signal by N clock cycles through the delay subcircuit; and
obtaining, in (M+N)^{th} clock cycle based on the second signal, the first data output by the target register.

3. The method according to claim 1, wherein the data delay circuit further comprises a first counter and a second counter,
wherein a value of the first counter cycles from 1 to N, and a value of the second counter cycles from 1 to N,
wherein in the M^{th} clock cycle, the value of the first counter is L, and
when M is greater than N, in the M^{th} clock cycle, the value of the second counter is L.

4. The method according to claim 3, wherein the first counter is configured to perform a first counting operation when a first signal is received and the first signal is a valid signal, and wherein the method further comprises: performing, by the second counter, a second counting operation when a second signal is received and the second signal is a valid signal.

5. The method according to claim 1, wherein when M is an integer multiple of N, a value of L is the same as a value of N; or when M is not an integer multiple of N, a value of L is the same as a value obtained through M modulo N.

6. A data delay circuit comprising: a first counter; a second counter; a delay subcircuit; N first registers; a first selection element; and a second selection element, wherein N is an integer greater than 1; and wherein:
an input end of the first counter is electrically connected to an input end of the second counter through the delay subcircuit, an output end of the first counter is electrically connected to a control end of the first selection element, and an output end of the second counter is electrically connected to a control end of the second selection element;
N output ends of the first selection element are electrically connected to data input ends of the N first registers in one-to-one correspondence, and the first selection element is configured to control a data input end of the first selection element to communicate with a first register associated with a value of the first counter through a data output end of the first selection element; and
N input ends of the second selection element are electrically connected to the data output ends of the N first registers in one-to-one correspondence, and the second selection element is configured to control a data output end of the second selection element to communicate with the first register associated with the value of the second counter through a data input end of the second selection element.

7. The data delay circuit according to claim 6, wherein the first selection element or the second selection element is a one-of-N selector.

8. An electronic device, comprising: a processor, a memory, and a program or an instruction that is stored in the memory and that is run on the processor, wherein when the program or the instruction is executed by the processor, cause the processor to perform operations comprising:
storing first data in a target register in M^{th} clock cycle, wherein the target register is L^{th} first register of N first registers in a data delay circuit of the electronic device; and
when M is greater than N, obtaining, in the M^{th} clock cycle, second data output by the target register, wherein the second data is data stored in the target register in (M−N)^{th} clock cycle.

9. The electronic device according to claim 8, wherein the data delay circuit further comprises a delay subcircuit formed by sequentially cascading N second registers, wherein the storing first data in a target register in M^{th} clock cycle comprises:
when a first signal is a valid signal, storing the first data in the target register in the M^{th} clock cycle; and
the operations further comprise:
inputting the first signal into the delay subcircuit;
obtaining a second signal obtained by delaying the first signal by N clock cycles through the delay subcircuit; and
obtaining, in (M+N)^{th} clock cycle based on the second signal, the first data output by the target register.

10. The electronic device according to claim 8, wherein the data delay circuit further comprises a first counter and a second counter,
wherein a value of the first counter cycles from 1 to N, and a value of the second counter cycles from 1 to N,
wherein in the M^{th} clock cycle, the value of the first counter is L, and
when M is greater than N, in the M^{th} clock cycle, the value of the second counter is L.

11. The electronic device according to claim 10, wherein the first counter is configured to perform a first counting operation when a first signal is received and the first signal is a valid signal, and wherein the operations further comprise: performing, by the second counter, a second counting operation when a second signal is received and the second signal is a valid signal.

12. The electronic device according to claim 8, wherein when M is an integer multiple of N, a value of L is the same as a value of N; or when M is not an integer multiple of N, a value of L is the same as a value obtained through M modulo N.
